(19) United States
(12) Patent Application Publication
(10) Pub. No.: US 2026/0011167 A1
(43) Pub. Date: Jan. 8, 2026

(54) IMAGE READING APPARATUS, IMAGE READING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventors: Akifumi SUGANO, KITAKYUSHU-SHI (JP); Yasuhisa YAMAMOTO, KITAKYUSHU-SHI (JP); Teiko HANAWA, ASAHI-MURA (JP)

(21) Appl. No.: 19/254,305

(22) Filed: Jun. 30, 2025

(30) Foreign Application Priority Data
Jul. 3, 2024 (JP) 2024-107689

(51) Int. Cl. G06V 30/24; G06T 7/13; G06T 7/136; G06T 7/90; G06V 10/28; G06V 30/18; H04N 1/00; H04N 1/40; H04N 1/409

(52) U.S. Cl. CPC G06V 30/24; G06T 7/13; G06T 7/136; G06T 7/90; G06V 10/28; G06V 30/1801; H04N 1/00798; H04N 1/40062; H04N 1/4092; G06T 2207/10024; H04N 2201/0081

(57) ABSTRACT

The image reading apparatus includes a reading section and a control section. The control section includes an image acquisition unit, a threshold setting unit, and a binarization processing unit. The threshold setting unit performs threshold setting processing including second processing and third processing, thereby setting a threshold used for binarization processing for each pixel of a read image. The second processing sets a threshold for binarizing a background pixel as a pixel of a background image into white. The third processing sets a threshold for binarizing a character pixel as a pixel of a character image into black. The binarization processing unit generates a binarized image from the read image based on the threshold set for each pixel. The threshold setting unit sets a threshold determined based on each brightness value of n×n pixels containing a pixel as a pixel of interest for the pixel of interest.

The present application is based on, and claims priority from JP Application Serial Number 2024-107689, filed Jul. 3, 2024, the disclosure of which is hereby incorporated by reference herein in its entirety.

### BACKGROUND

### 1. Technical Field

The present disclosure relates to an image reading apparatus including a reading section that reads a document, an image reading method, and a non-transitory computer-readable storage medium storing a program.

### 2. Related Art

For example, JP-A-2004-127258 discloses an image processing apparatus that employs a binarization processing method for binarizing image data of a security. The image processing apparatus includes a binarization processing method determination unit and an image acquisition unit. The binarization processing method determination unit determines a binarization processing method based on image data of part of the security. The image acquisition unit converts the image data of the entire security into a binarized image based on the binarization processing method determined by the binarization processing method determination unit.

The binarization processing method determination unit determines whether the binarization processing method is “threshold calculation method” or “sharpness method”. When the method is “threshold calculation method”, the image acquisition unit calculates a threshold and acquires a binarized image from grayscale data of the read image using the threshold. On the other hand, when the method is “sharpness method”, the image acquisition unit performs sharpening image processing on the grayscale data of the read image and acquires a binarized image using a predetermined threshold.

As a result, the image processing apparatus acquires an accurate binarized image according to a security such as a check to be used. From the binarized image, important character information such as an account number, a payment amount, a payer, a recipient, and a signature on the security can be accurately acquired.

JP-A-2004-127258 is an example of the related art.

However, in a binarized image of a document such as a security obtained by the image reading apparatus, in order to improve recognition accuracy of character information, it is desired that characters and backgrounds are more easily distinguished.

### SUMMARY

An image reading apparatus according to an aspect of the present disclosure is an image reading apparatus that reads a document containing a background and a character, the apparatus including a reading section that reads the document, and a control section, wherein the control section includes an image acquisition unit that performs first processing of acquiring a read image containing a background image and a character image by causing the reading section to read the document, a threshold setting unit that performs threshold setting processing including second processing of setting a threshold for binarizing a background pixel as a pixel of the background image contained in the read image into a first color that is one color of black and white and third processing of setting a threshold for binarizing a character pixel as a pixel of the character image contained in the read image into a second color that is the other color of black and white, thereby setting the threshold used for binarization processing for each pixel of the read image, and a binarization processing unit that generates a binarized image from the read image based on the threshold set for each pixel, and the threshold setting processing includes processing of setting a threshold determined based on each brightness value of n×n pixels containing the pixel as a pixel of interest for the pixel of interest by the threshold setting unit.

An image reading method according to an aspect of the present disclosure is an image reading method of reading a document containing a background and a character, with a reading section that reads the document and a control section, the method including, by the control section, performing first processing of acquiring a read image containing a background image and a character image by causing the reading section to read the document, performing threshold setting processing including second processing of setting a threshold for binarizing a background pixel as a pixel of the background image contained in the read image into a first color that is one color of black and white and third processing of setting a threshold for binarizing a character pixel as a pixel of the character image contained in the read image into a second color that is the other color of black and white, thereby setting the threshold used for binarization processing for each pixel of the read image, and generating a binarized image from the read image based on the threshold set for each pixel, wherein the threshold setting processing includes processing of setting a threshold determined based on each brightness value of n×n pixels containing the pixel as a pixel of interest for the pixel of interest.

A non-transitory computer-readable storage medium storing a program according to an aspect of the present disclosure, the program causes a computer provided in an image reading apparatus that reads a document containing a background and a character to execute image reading processing including performing first processing of acquiring a read image containing a background image and a character image by causing a reading section to read the document by an image acquisition unit of the computer, performing threshold setting processing including second processing of setting a threshold for binarizing a background pixel as a pixel of the background image contained in the read image into a first color that is one color of black and white and third processing of setting a threshold for binarizing a character pixel as a pixel of the character image contained in the read image into a second color that is the other color of black and white, thereby setting the threshold used for binarization processing for each pixel of the read image by a threshold setting unit of the computer, and generating a binarized image from the read image based on the threshold set for each pixel by a binarization processing unit of the computer, wherein the threshold setting processing includes processing of setting a threshold determined based on each brightness value of n×n pixels containing the pixel as a pixel of interest for the pixel of interest.

### BRIEF DESCRIPTION OF THE DRAWINGS

FIG. 1 is a perspective view showing an image reading apparatus in an embodiment.

FIG. 2 is a schematic plan sectional view showing the image reading apparatus.

FIG. 3 is a schematic diagram showing a security as a document.

FIG. 4 is a schematic diagram showing a read image of the security.

FIG. 5 is a block diagram showing an electrical configuration of the image reading apparatus and a host device.

FIG. 6 is a block diagram showing a functional configuration of a control section.

FIG. 7 is a flowchart showing a main program.

FIG. 8 is a flowchart showing a mean edge intensity calculation processing routine.

FIG. 9 is a flowchart showing a planar region threshold image generation processing routine.

FIG. 10 is a histogram showing a relationship between a brightness value and the number of pixels of a grayscale image.

FIG. 11 is a schematic diagram showing an edge detection image.

FIG. 12 is a schematic diagram showing an edge detection image in which edge regions are separated.

FIG. 13 is a graph illustrating a method of calculating a threshold by edge region threshold calculation processing.

FIG. 14 is a schematic diagram showing an image for explaining mean edge intensity calculation processing.

FIG. 15 is a schematic diagram showing an image for explaining the mean edge intensity calculation processing.

FIG. 16 is a schematic diagram showing an image for explaining planar region threshold image generation processing.

FIG. 17 is a schematic diagram showing a binarized image of a comparative example.

FIG. 18 is a schematic diagram showing a binarized image of an example.

### DESCRIPTION OF EMBODIMENTS

As below, an example of an image reading apparatus will be described with reference to the drawings. The image reading apparatus is, for example, a scanner that reads an image such as a character or a photograph printed on a document such as a sheet or a film.

### Image Reading Apparatus

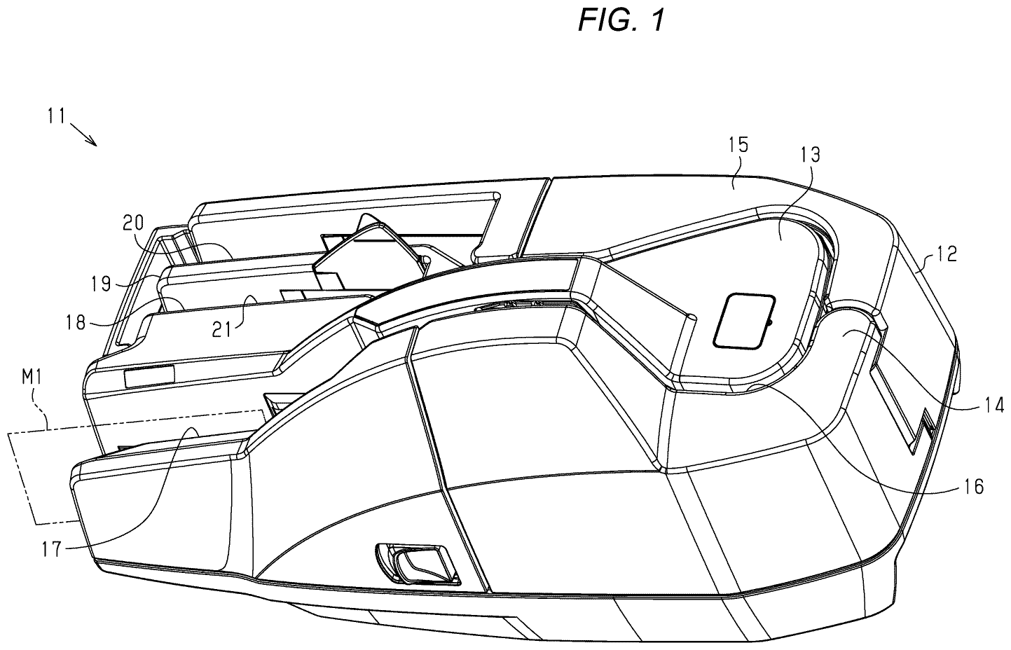

As illustrated in FIG. 1, an image reading apparatus 11 includes a housing 12. The housing 12 includes a frame, a cover that covers the frame, and the like. As an example, the housing 12 includes a first housing portion 13, a second housing portion 14, and a third housing portion 15 that are coupled to one another.

The first housing portion 13 is located between the second housing portion 14 and the third housing portion 15. The second housing portion 14 and the third housing portion 15 are attached so as to rotate with respect to the first housing portion 13. When the second housing portion 14 or the third housing portion 15 rotates, the inside of the housing 12 is exposed.

A transport route 16 is formed in the housing 12. The transport route 16 extends in the housing 12. The transport route 16 is a route in which a document M1 is transported. The transport route 16 includes, for example, a slit formed in the housing 12. In one example, the transport route 16 extends between the first housing portion 13 and the second housing portion 14 and between the first housing portion 13 and the third housing portion 15.

A supply space 17 is formed in the housing 12. A bundle of documents including a plurality of documents M1 before reading is set in the supply space 17. The supply space 17 communicates with the transport route 16. The document M1 is supplied to the transport route 16 from the bundle of documents set in the supply space 17.

An ejection space 18 is formed in the housing 12. The document M1 after reading is held in the ejection space 18. The ejection space 18 communicates with the transport route 16. The document M1 passing through the transport route 16 is ejected to the ejection space 18.

The image reading apparatus 11 may include a partition plate 19 that divides the ejection space 18 into two. As an example, the partition plate 19 partitions the ejection space 18 into a first holding space 20 and a second holding space 21. The document M1 correctly read is held in the first storage space 20. The document M1 not correctly read is held in the second storage space 21. The image reading apparatus 11 may include a flap (not illustrated) that sorts the documents M1 to be ejected to the ejection space 18.

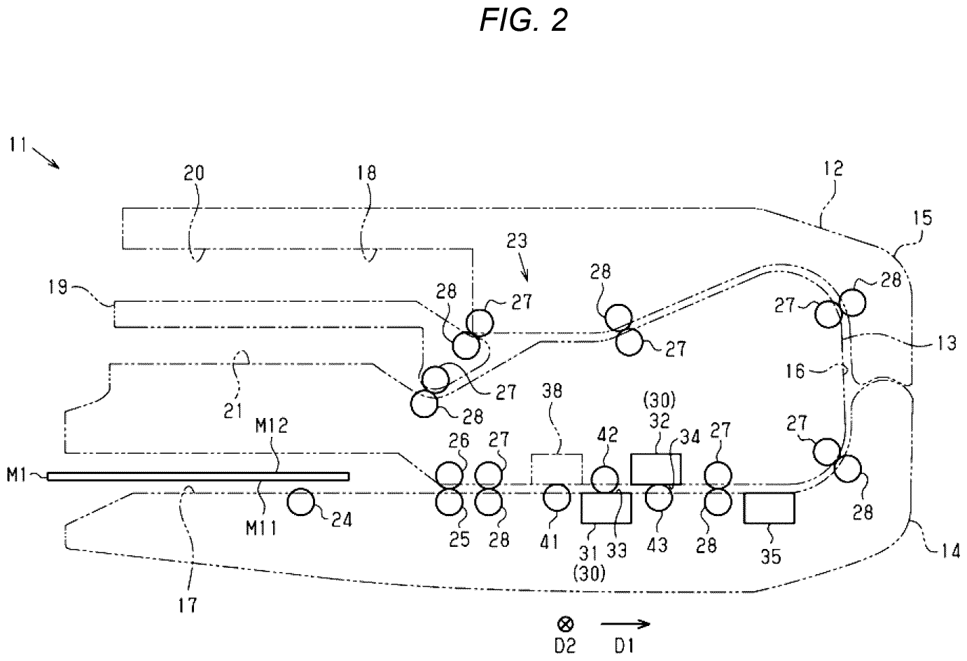

As illustrated in FIG. 2, the image reading apparatus 11 includes a transport unit 23. The transport unit 23 is configured to transport the document M1 along the transport route 16. The transport unit 23 transports the document M1 from the supply space 17 toward the ejection space 18.

The transport unit 23 includes a plurality of rollers. The plurality of rollers are disposed along the transport route 16. The transport unit 23 transports the document M1 from upstream to downstream of the transport route 16 by the plurality of rollers.

The transport unit 23 includes a pick roller 24. The pick roller 24 is configured to supply the document M1 from the supply space 17 to the transport route 16. The pick roller 24 transports one document M1 in contact with the pick roller among the bundle of documents set in the supply space 17 to the transport route 16.

The transport unit 23 includes a transport roller 25. The transport roller 25 transports the document M1 supplied by the pick roller 24. The transport roller 25 is a roller located most upstream in the transport route 16. The transport roller 25 is driven to rotate, thereby transporting the document M1 along the transport route 16.

The transport unit 23 includes a separation roller 26. The separation roller 26 separates the documents M1 supplied by the pick roller 24 one by one. The separation roller 26 faces the transport roller 25. The separation roller 26 rotates, for example, to return the document M1 from the transport route 16 to the supply space 17, thereby separating the documents M1 one by one.

The transport unit 23 includes one or more driving rollers 27. In one example, the transport unit 23 includes a plurality of driving rollers 27. The plurality of driving rollers 27 are disposed along the transport route 16. The driving roller 27 is driven to rotate, thereby transporting the document M1 along the transport route 16.

The transport unit 23 includes one or more driven rollers 28. In one example, the transport unit 23 includes a plurality of driven rollers 28. The transport unit 23 includes the same number of driven rollers 28 as the driving rollers 27. The plurality of driven rollers 28 are disposed along the transport route 16. The driven roller 28 faces the driving roller 27. The driven roller 28 rotates to follow the driving roller 27, thereby transporting the document M1 along the transport route 16.

The image reading apparatus 11 includes one or more reading sections 30. Specifically, the image reading apparatus 11 includes a first reading unit 31 and a second reading unit 32 as the reading section 30. The reading section 30 is configured to read an image of the document M1. The reading section 30 is disposed at a position along the transport route 16. The reading section 30 reads the document M1 transported in the transport route 16. The first reading unit 31 reads a first surface M11 of the document M1. The second reading unit 32 reads a second surface M12.

The first reading unit 31 and the second reading unit 32 may read the document M1 at the same time or may read the document M1 in order. That is, the first reading unit 31 and the second reading unit 32 may face each other in the transport route 16 or may be disposed without facing each other. In one example, the first reading unit 31 is located upstream of the second reading unit 32 in the transport route 16. Accordingly, the first reading unit 31 reads the document M1 earlier than the second reading unit 32.

Each of the first reading unit 31 and the second reading unit 32 has a reading surface. The first reading unit 31 has a first reading surface 33. The second reading unit 32 has a second reading surface 34. The reading surface is a surface facing the document M1 in the reading unit. In one example, the first reading surface 33 faces the first surface M11. The second reading surface 34 faces the second surface M12.

The reading section 30 includes a plurality of image sensors arranged in one direction. In one example, the reading section 30 includes a plurality of image sensors arranged in the vertical direction. The reading unit is a so-called CISM.

The image reading apparatus 11 may include a magnetic reading unit 35. The magnetic reading unit 35 is configured to read magnetic ink. The magnetic reading unit 35 is a so-called MICR. For example, the magnetic reading unit 35 reads characters, symbols, and the like printed with magnetic ink from securities such as checks. Accordingly, in one example, the image reading apparatus 11 is a scanner that can read securities such as checks. A flap (not illustrated) may sort the documents M1 based on the reading results of the magnetic reading unit 35.

The image reading apparatus 11 includes three or more nip portions that curve the document M1 in a wavy manner. For example, the document M1 is pressed against a pressure receiving portion 38 by a first pressing roller 41 at a position upstream of the reading position. At the downstream first reading position, the document M1 is pressed against the first reading unit 31 by a second pressing roller 42. At the downstream second reading position, the document M1 is pressed against the second reading unit 32 by a third pressing roller 43. Accordingly, the document M1 is curved in a wavy manner, and a tension is applied to the document M1. The tension is applied to the document M1, thereby stretching wrinkles, folds, and the like produced in the document M1. As a result, the first reading unit 31 and the second reading unit 32 can read the document M1 without wrinkles, folds, or the like.

### Security and Read Image Thereof

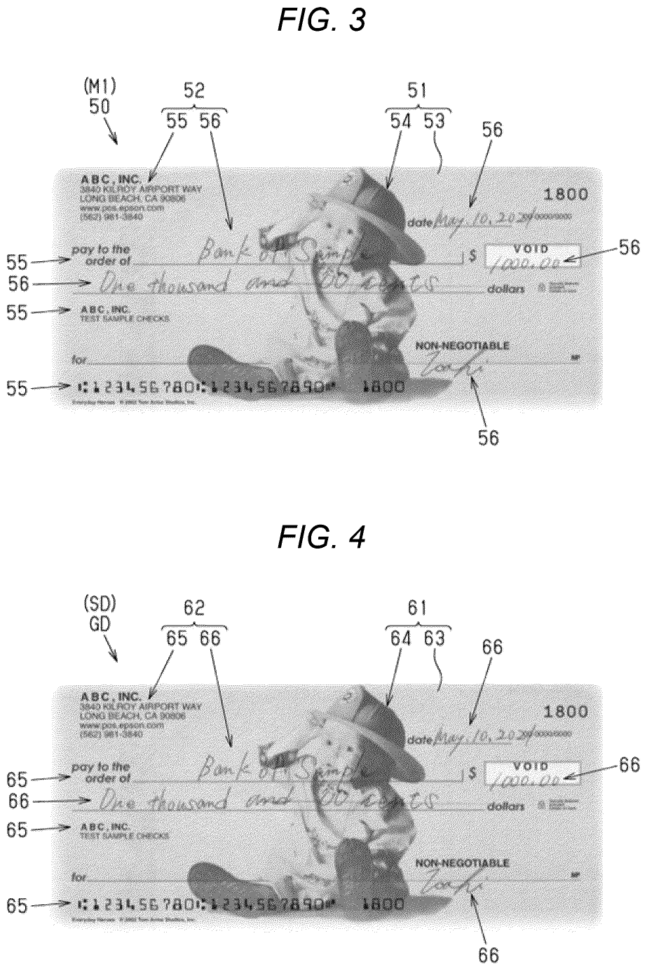

A security to be read by the image reading apparatus 11 and a read image GD (SD) thereof will be described with reference to FIG. 3. A security 50 shown in FIG. 3 is, for example, a check. The security 50 contains backgrounds 51 and characters 52. The backgrounds 51 include a ground pattern 53, a design 54 including a figure and a picture, and the like. The characters 52 include printed characters 55, handwritten characters 56, and the like. When the security 50 as an example of a document is a check, the size thereof is 85 mm long×185 mm wide, and the area thereof is 15725 square mm.

When character recognition is performed using the read image read by the image reading apparatus 11 as it is, the recognition accuracy of the characters 52 may be lower due to interference by the backgrounds 51. Accordingly, in the image reading apparatus 11 of the embodiment, after the read image of the security 50 is converted into a binarized image, character recognition is performed using the binarized image.

In JP-A-2004-127258, one of the two methods of the threshold calculation method and “sharpness method” is adopted as the binarization processing method. However, it is not easy enough to distinguish between the backgrounds and the characters in the binarized image. For example, depending on the threshold, a part of the background becomes black and is mixed with the black part of the character, and thus the recognition accuracy of the character becomes lower. The image reading apparatus 11 of the embodiment provides a processing method for generating a binarized image in which the backgrounds 51 and the characters 52 are more clearly distinguished from the read image.

The read image GD shown in FIG. 4 is obtained by converting the color read image SD into a grayscale image. The read image GD includes background images 61 corresponding to the backgrounds 51 and character images 62 corresponding to the characters 52. The background images 61 include a ground pattern image 63 corresponding to the ground pattern 53 and a design image 64 corresponding to the design 54. The character images 62 include printed character images 65 corresponding to the printed characters 55 and handwritten character images 66 corresponding to the handwritten characters 56.

### Electrical Configuration of Image Reading Apparatus 11

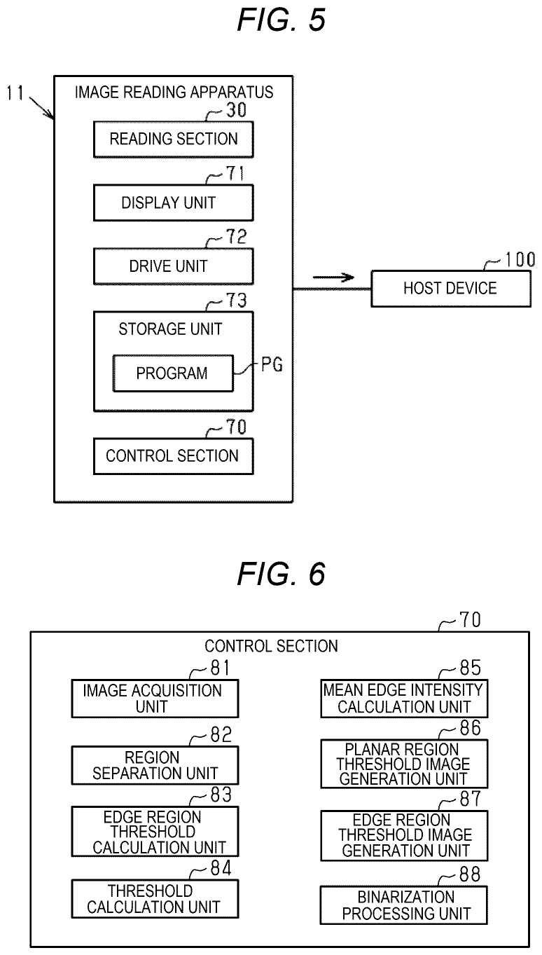

Next, an electrical configuration of the image reading apparatus 11 will be described with reference to FIG. 5.

As illustrated in FIG. 5, the image reading apparatus 11 includes the reading section 30, a display unit 71, a drive unit 72, and a control section 70. The control section 70 includes a storage unit 73. The reading section 30 includes the first reading unit 31 and the second reading unit 32.

The image reading apparatus 11 is communicably connected to a host device 100. The connection between the image reading apparatus 11 and the host device 100 may be wired or wireless. The host device 100 may be a personal computer (PC), a smartphone, a mobile phone, or the like. Specifically, the control section 70 of the image reading apparatus 11 communicates with the host device 100.

The reading section 30 reads the image of the security 50 transported by the drive unit 72 driving the transport roller and the like in the middle of the transport route. The read image read by the reading section 30 is stored in a predetermined storage area of the storage unit 73. The control section 70 generates a binarized image BI (FIG. 18) by performing various types of processing on the read image SD read from the storage unit 73. The storage unit 73 stores a program PG for execution of various types of processing including the processing of generating the binarized image BI from the read image SD. The control section 70 transmits image data of the read image SD, the binarized image BI, and the like read by the reading section 30 from an object for reading such as a security to the host device 100.

The control section 70 may include a computer including a microprocessor or the like. The computer may include the storage unit 73 (memory) including a RAM, a nonvolatile memory, and the like. That is, all or a part of the storage unit 73 may be provided in the control section 70. The storage unit 73 stores the program PG.

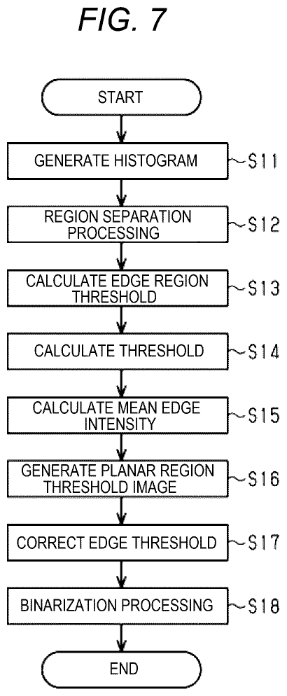

The program PG includes programs shown by flowcharts in FIGS. 7 to 9. The control section 70 is not limited to the one that performs software processing for all processing executed by itself. For example, the control section 70 may include a dedicated hardware circuit (for example, an application specific integrated circuit: ASIC) that performs hardware processing for at least part of processing execute by itself. That is, the control section 70 may be configured as a circuitry including one or more processors that operate according to a computer program (software), one or more dedicated hardware circuits that execute at least part of various types of processing, or a combination thereof. The processor includes a CPU and a memory such as a RAM and a ROM, and the memory stores program codes or instructions configured to cause the CPU to execute the processing. The memory, that is, a computer-readable medium includes any available medium that can be accessed by a general-purpose or dedicated computer.

The control section 70 includes, for example, a CPU (Central Processing Unit). The control section 70 includes a computer including a CPU and the storage unit 73. The control section 70 performs various types of processing for implementing various functions of the image reading apparatus 11 by the CPU executing the program PG.

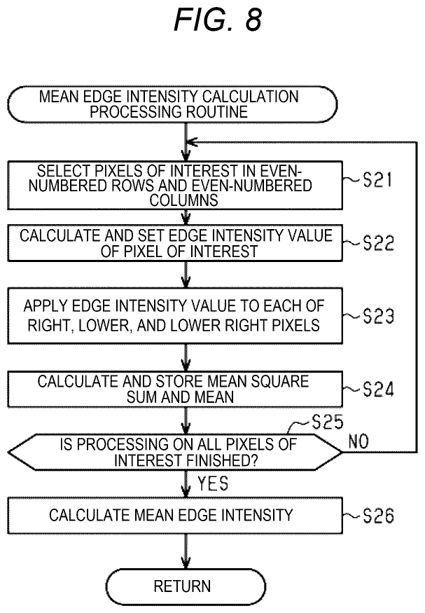

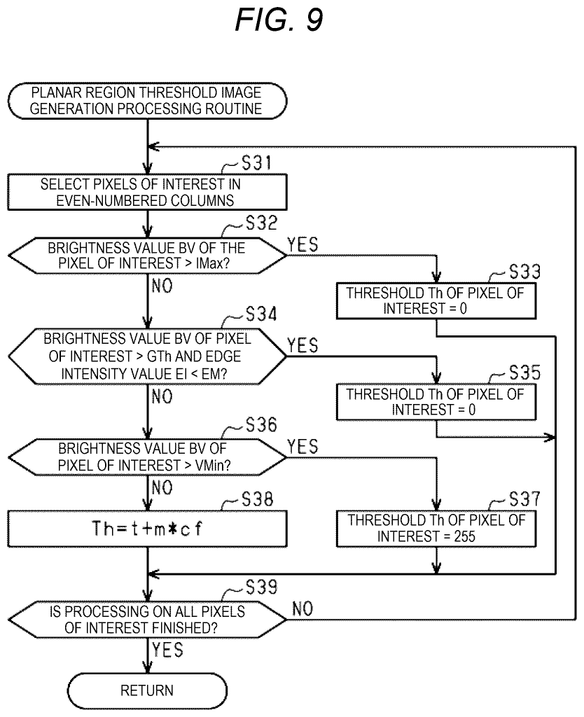

The program PG includes the programs shown by flowcharts in FIGS. 7 to 9. The flowchart shown in FIG. 7 corresponds to a main program for the CPU to execute processing of generating the binarized image BI from the read image SD of the security. The main program includes a program group that performs various types of processing for generating the binarized image BI from the read image SD. FIGS. 8 and 9 are the flowcharts showing two programs of the program group.

Specifically, the main program shown in FIG. 7 includes an image acquisition program, a region separation program, an edge region threshold calculation program, a threshold calculation program, a mean edge intensity calculation program, a planar region threshold image generation program, an edge region threshold image generation program, and a binarization processing program. The program shown in FIG. 8 is the mean edge intensity calculation program. The program illustrated in FIG. 9 is the planar region threshold image generation program.

### Functional Configuration of Control Section 70

Next, a functional configuration of the control section 70 will be described. The control section 70 includes a plurality of functional portions configured by the CPU of the computer executing various programs stored in the storage unit 73. That is, the control section 70 includes an image acquisition unit 81, a region separation unit 82, an edge region threshold calculation unit 83, a threshold calculation unit 84, a mean edge intensity calculation unit 85, a planar region threshold image generation unit 86, an edge region threshold image generation unit 87, and a binarization processing unit 88. The edge region threshold calculation unit 83, the planar region threshold image generation unit 86, the edge region threshold image generation unit 87, and the like forms an example of a threshold setting unit.

As below, these functional units forming the control section 70 will be described with reference to FIGS. 10 to 16.

The image acquisition unit 81 includes a CPU that executes the image acquisition program. The image acquisition unit 81 acquires the read image SD read by the reading section 30. The read image SD includes the background images 61 and the character images 62. The image acquisition unit 81 converts the R, G, and B values of all pixels according to the resolution into brightness values (density values). That is, the read image SD acquired from the reading section 30 by the image acquisition unit 81 is an RGB color image. The image acquisition unit 81 converts the read image SD as a color image into the read image GD as a grayscale image. The image acquisition unit 81 performs first processing of acquiring the read image GD (SD) including the background images 61 and the character images 62 by causing the reading section 30 to read the document M1. After converting the RGB pixel values of the read image SD into brightness values, the image acquisition unit 81 creates a histogram H1 (see FIG. 10) of brightness values for the read image GD as the grayscale image.

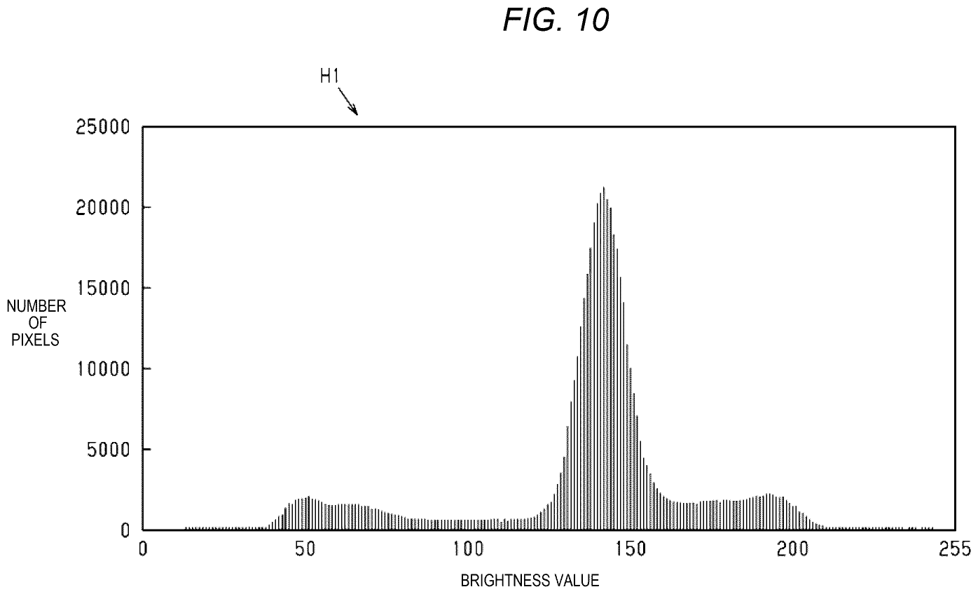

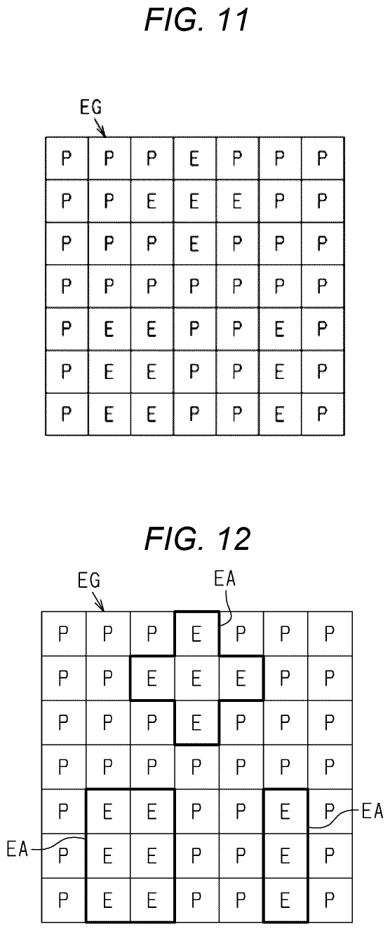

The image acquisition unit 81 may detect edge pixels E (see FIG. 11). Here, the pixels forming the background images 61 are referred to as planar pixels P, and the pixels forming the character images 62 are referred to as the edge pixels E. The edge pixel E has higher density than the planar pixel P. The image acquisition unit 81 calculates, for each pixel of the grayscale image, density differences between a pixel of interest and pixels around the pixel of interest to generate a frequency distribution of the density differences with respect to each pixel of interest. The frequency of the frequency distribution is the number of pixels. The image acquisition unit 81 detects the pixel of interest that satisfies an edge pixel detection condition that the frequency distribution of the density differences is biased to a larger absolute value of the density difference as an edge pixel E. The pixel of interest that does not satisfy the pixel detection condition is regarded as a planar pixel P (see FIG. 11). In this manner, the image acquisition unit 81 detects the edge pixels E from the grayscale image. That is, the image acquisition unit 81 detects the edge pixels E and the planar pixels P from the grayscale image. In this manner, the image acquisition unit 81 acquires an edge detection image EG shown in FIG. 11. The edge detection image EG is used by the region separation unit 82. The processing executed by the image acquisition unit 81 corresponds to the first processing. That is, the first processing includes processing of reading the read image SD including the background images 61 and the character images 62.

The region separation unit 82 includes a CPU that executes the region separation program. The region separation unit 82 executes processing of generating an edge region EA (see FIG. 12) by coupling the portions determined as edge pixels of the input image. That is, the region separation unit 82 separates the edge region EA, which is a region in which the edge pixels E are connected, from the edge detection image EG (FIG. 11) input from the image acquisition unit 81. Specifically, the region separation unit 82 searches in eight directions around the edge pixel E, and couples the edge pixels E when there is the same edge pixel E. The coupling processing is performed for all edge pixels E, thereby separating the edge regions EA. The region separation unit 82 counts and stores the number of pixels with respect to each of the obtained edge regions EA in the storage unit 73.

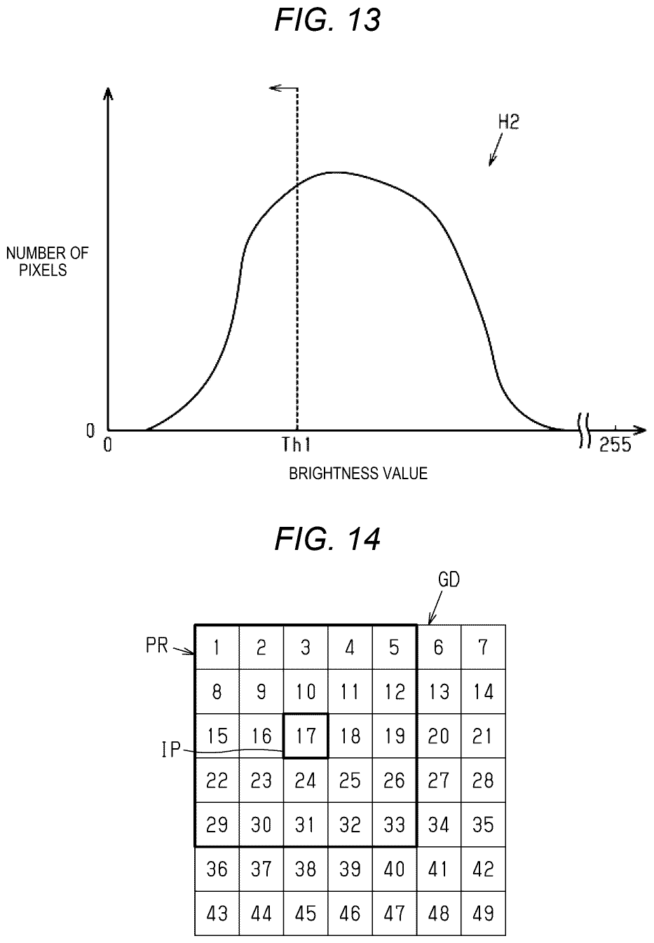

The edge region threshold calculation unit 83 includes a CPU that executes the edge region threshold calculation program. The edge region threshold calculation unit 83 calculates a threshold for each edge region EA separated by the region separation unit 82. For the threshold of the edge region EA, a histogram H2 (FIG. 13) is created in the edge region EA, and the brightness value when the cumulative number of pixels from the smaller brightness values reaches a certain value is set as a threshold Th1. The certain value is a value obtained by multiplying the total number of pixels in the edge region EA by a predetermined ratio. The predetermined ratio is, for example, “0.4”. The certain value is the total number of pixels of the edge region EA×0.4. The predetermined ratio may be, for example, another value within a range from 0.2 to 0.6 instead of “0.4”, or a value outside the range may be adopted.

The threshold calculation unit 84 includes a CPU that executes the threshold calculation program. The threshold calculation unit 84 calculates a first threshold GTh using the histogram H1 of the entire image illustrated in FIG. 10 and a degree S of separation obtained by the following predetermined threshold selection processing. The contents of the predetermined threshold selection processing are shown below.

First, means mt and variances σ² of the histogram H1 of the entire image are obtained. Then, a threshold T is optionally determined. The mean m1 and the variance σ₁² are obtained in a range (first class) smaller than the threshold T (boundary value T) of the histogram H1. The mean m2 and the variance σ₂² are obtained in a range (second class) larger than the threshold T of the histogram H1.

An intra-class variance σ_{w}² is obtained by the following expression (1).

$${σ}_{w}^{2} = \frac{{ω}_{1} {σ}_{1}^{2} + {ω}_{2} {σ}_{2}^{2}}{{ω}_{1} + {ω}_{2}} \qquad ( 1 )$$

Here, ω1 is the number of pixels of the first class, and ω2 is the number of pixels of the second class.

Further, an inter-class variance σ_{b}² is obtained by the following expression (2).

$$\begin{matrix}{σ}_{b}^{2} = \frac{{{ω}_{1} ( {m}_{1} - {m}_{t} )}^{2} + {{ω}_{2} ( {m}_{2} - {m}_{t} )}^{2}}{{ω}_{1} + {ω}_{2}} \\ = \frac{{ω}_{1} {{ω}_{2} ( {m}_{1} - {m}_{2} )}^{2}}{{( {ω}_{1} + {ω}_{2} )}^{2}}\end{matrix} \qquad ( 2 )$$

Here, ω1 is the number of pixels of the first class, ω2 is the number of pixels of the second class, m1 is the mean of the first class, and m2 is the mean of the second class.

The degree of separation S is obtained by the following expression (3).

$$S = \frac{{σ}_{b}^{2}}{{σ}_{w}^{2}} \qquad ( 3 )$$

Then, the new next threshold T is set, and the degree of separation S is similarly obtained at the next threshold T. When the degrees of separation S are obtained with the thresholds T from 0 to 255, the threshold T at which the maximum degree of separation S is obtained of these thresholds T is set as the first threshold GTh. The first threshold GTh is an example of a second determination value.

The mean edge intensity calculation unit 85 includes a CPU that executes the mean edge intensity calculation program. The mean edge intensity calculation unit 85 obtains an edge intensity value of the pixel of interest. The variance of the brightness values in a range PR of n×n from the pixel of interest is calculated. The mean edge intensity calculation unit 85 sets the calculated variance value as the edge intensity value. Here, an example in which n=5 and the variance of the brightness values in the range PR of 5×5 from the pixel of interest is calculated will be described.

The mean edge intensity calculation unit 85 performs calculation for 5×5 in the following manner. Note that, in the read image GD illustrated in FIG. 14, for the sake of simplicity, it is assumed that the entire image is formed by 7×7 pixels. The smallest frame in the drawing indicates one pixel. The number in the pixel corresponds to an address. The horizontal direction is the row direction, and the vertical direction is the column direction. The first column, the second column, are arranged in order from the top, and the first row, the second row, . . . are arranged in order from the left. In the example shown in FIG. 14, the pixel at the address “17” is a pixel of interest IP. All brightness values in the range PR of 5×5 around the pixel of interest IP are acquired and the variance is calculated. This calculation is performed for all pixels by sequentially changing the pixel of interest IP.

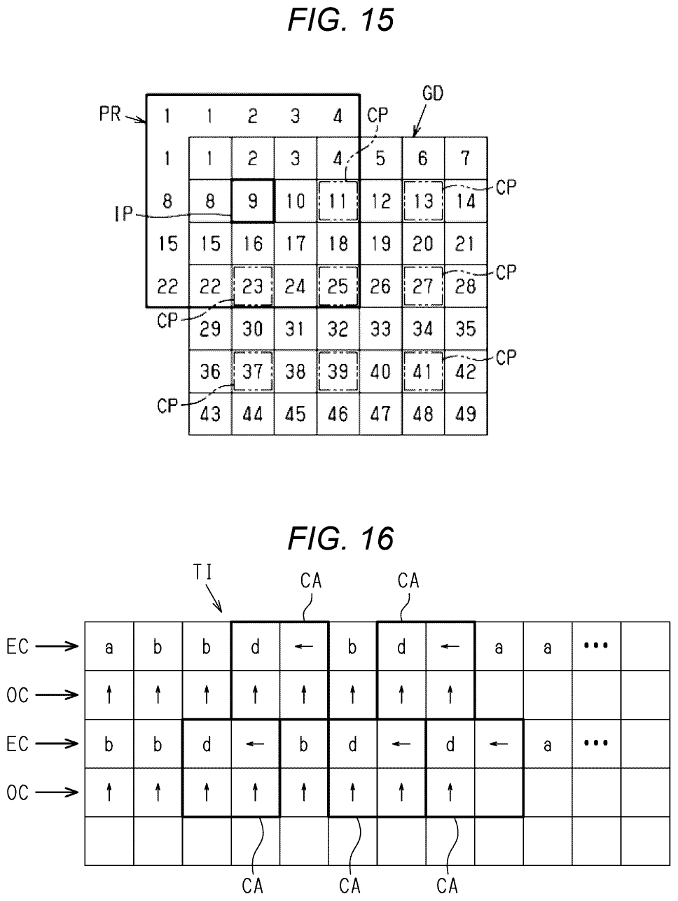

Here, in order to shorten the calculation processing time, the mean edge intensity calculation unit 85 may skip every other pixel in at least one of the row and the column when selecting the pixel of interest in the calculation of the edge intensity value. For example, as illustrated in FIG. 15, the mean edge intensity calculation unit 85 may calculate the edge intensity value by selecting only pixels in even-numbered rows and even-numbered columns as the pixels of interest IP. In FIG. 15, candidate pixels CP for the pixel of interest IP to be selected as the pixel of interest in the subsequent calculation after the current calculation of the pixel of interest IP are indicated by two-dot chain lines. In this manner, only pixels in even-numbered rows and even-numbered columns may be selected as the pixels of interest IP (CP).

As illustrated in FIG. 15, when the range PR of n×n (for example, 5×5) including the address “9” is acquired, part of the pixels in the range PR may be outside the read image GD. In this case, as illustrated in FIG. 15, the brightness values of adjacent pixels may be copied and used for the pixels outside the read image GD in the range PR.

In this manner, the mean edge intensity calculation unit 85 acquires the variance for each pixel of interest IP as an edge intensity value EI. That is, the mean edge intensity calculation unit 85 calculates the edge intensity values EI for all pixels of the read image GD. The mean edge intensity calculation unit 85 obtains the edge intensity values EI of all pixels, and then, obtains the mean value of the edge intensity values EI. That is, the mean edge intensity calculation unit 85 calculates a mean edge intensity value EM as the mean value of the edge intensity values EI by dividing the sum of the edge intensity values EI of all pixels by the number of pixels.

In the example illustrated in FIG. 15, the mean edge intensity calculation unit 85 selects only pixels in even-numbered rows and even-numbered columns as the pixels of interest IP and performs calculation processing. Accordingly, the amount of calculation by the mean edge intensity calculation unit 85 calculating the edge intensity value EI for each pixel and the mean edge intensity value EM of the read image GD becomes about ¼. Therefore, the required calculation processing time of the mean edge intensity calculation unit 85 becomes about ¼.

When acquiring the n×n (for example, 5×5) brightness values, the mean edge intensity calculation unit 85 calculates and stores a mean square sum std and a mean m (the mean of the sum) in the storage unit 73. This is because the planar region threshold image generation unit 86 that performs the next processing uses the mean square sum std and the mean m of the n×n brightness values. Here, the mean edge intensity calculation unit 85 obtains the mean square sum std by adding all square values of the brightness values of the respective pixels and dividing the sum by the number of pixels “n²” (as an example, “25”). The mean edge intensity calculation unit 85 calculates the mean by adding the brightness values of all n×n (for example, 5×5) pixels and dividing the sum by the number of pixels “n²” (for example, “25”). The processing of reading the n×n brightness values from the storage unit 73 while sequentially changing the pixel of interest takes time. Therefore, individual performance of the processing by the mean edge intensity calculation unit 85 and the planar region threshold image generation unit 86 is avoided. When calculating the variance of the n×n brightness values, the mean edge intensity calculation unit 85 calculates the mean square sum std and the mean m together using the n×n brightness values acquired at that time. This shortens the total processing time required from the start of document reading to the generation of the binarized image BI (FIG. 18).

The planar region threshold image generation unit 86 includes a CPU that executes the planar region threshold image generation program. The planar region threshold image generation unit 86 generates a planar region threshold image TI (see FIG. 16) in which the threshold is set for each pixel belonging to at least the planar region by setting the threshold for each pixel of the entire image. In the embodiment, the planar region threshold image generation unit 86 sets the threshold not only for the pixels in the planar region but also for the pixels in the edge region EA in this process.

The planar region threshold image generation unit 86 performs processing of calculating a threshold Th to be set for all pixels of the read image GD using the first threshold GTh calculated by the edge region threshold calculation unit 83 and the mean edge intensity value EM calculated by the mean edge intensity calculation unit 85. Whether the pixel of interest satisfies the following conditions (a) to (d) is determined in order for all pixels of the read image GD, and when the pixel of interest satisfies the condition, the threshold Th to be set when the condition is satisfied is obtained. Then, the obtained threshold Th is set as the pixel value of the pixel of interest. By setting the threshold Th for all pixels in this manner, the planar region threshold image TI is generated.

Hereinafter, the conditions (a) to (d), the threshold Th to be set in case where each condition is satisfied, and a calculation method in case where calculation is necessary to acquire the threshold Th, and the like will be described.

(a) Whether a first condition that brightness value of pixel of interest>Imax is satisfied is determined. When the first condition is satisfied, the threshold Th of the pixel of interest is set to “0” (Th=0). That is, the threshold Th for setting the pixel of interest to white is set. Here, a constant Imax is an example of a first determination value. For example, Imax=200. The constant Imax is set to a high brightness value at which the pixel of interest has a higher and can be clearly determined as a background pixel. The constant Imax may be, for example, a value within a range of 180≤Imax≤230. Obviously, any value outside this range may be used as long as the pixel of interest has a higher brightness value and can be clearly determined as a background pixel. The processing related to (a) corresponds to an example of second processing of setting a threshold for binarizing a background pixel into a first color (white) that is one of black and white.

(b) Whether a second condition that brightness value of pixel of interest>GTh and edge intensity value<EM is satisfied is determined. Here, GTh is an example of a second determination value, and is the above described first threshold GTh calculated by the threshold calculation unit 84. The edge intensity value is the above described edge intensity value EI calculated by the mean edge intensity calculation unit 85. EM is the above described mean edge intensity EM calculated by the mean edge intensity calculation unit 85. That is, the control section 70 determines whether the second condition that the brightness value BV of the pixel of interest is larger than the threshold GTh and the edge intensity value EI is smaller than the mean edge intensity value EM is satisfied. Based on the second condition, whether the pixel of interest can be regarded as a background pixel with a high probability is determined. When the second condition is satisfied, the threshold Th of the pixel of interest is set to “0” (Th=0). That is, the threshold Th for setting the pixel of interest to white is set. The processing related to (b) corresponds to an example of the second processing of setting a threshold for binarizing a background pixel into the first color (white) that is one of black and white.

(c) Whether a third condition that brightness value of pixel of interest>Vmin is satisfied is determined. Here, a constant Vmin is an example of a third determination value, and is a value indicated by a product of the first threshold GTh and a constant Cm. Vmin=GTh*Cm. The symbol “*” is an operation symbol representing a product. The constant Cm is, for example, Cm=0.4. The constant Cm is set to a value at which Vmin can be set as a low brightness value and most of pixels having brightness values equal to or less than Vmin can be character pixels. The constant Vmin as the example of the third determination value is a value obtained by multiplying the first threshold GTh as the example of the second determination value by the constant Cmin. When the third condition is satisfied, the threshold Th of the pixel of interest is set to “255” (Th=255). That is, the threshold Th for setting the pixel of interest to black is set. The constant Cm may be, for example, a value within a range of 0.2≤Cm≤0.6. Obviously, any value outside this range may be used as the constant Cm as long as Vmin can be set as a low brightness value and most of pixels having brightness values equal to or less than Vmin can be character pixels. The processing related to (c) corresponds to an example of third processing of setting a threshold for binarizing the character pixel into a second color (black) which is the other color of black and white.

(d) For a pixel that does not satisfy any of the conditions (a), (b), and (c), a standard deviation t based on the n×n brightness values with the pixel as the pixel of interest is obtained. The planar region threshold image generation unit 86 calculates the threshold Th by an expression Th=t+m*cf using the standard deviation t and the mean m. Here, cf is a constant and is, for example, a value within a range of 0.5≤cf≤1.2. For example, cf may be 0.8. The constant cf may be a value outside the above range. The planar region threshold image generation unit 86 calculates the standard deviation t by reading the mean square sum std and the mean m based on the n×n brightness values from the storage unit 73 and using the values.

Therefore, it is not necessary for the planar region threshold image generation unit 86 to perform processing of accessing the storage unit 73 and reading the n×n brightness values, which is performed by the mean edge intensity calculation unit 85 for calculation of the edge intensity value EI. That is, it is not necessary to separately perform the processing of reading the pixel values of the n×n pixels by the mean edge intensity calculation unit 85 and the planar region threshold image generation unit 86. It is necessary to perform the processing of reading the n×n brightness values around the pixel of interest for all pixels only once. Therefore, the calculation time required for the control section 70 to set the threshold Th for all pixels can be shortened.

The planar region threshold image generation unit 86 obtains the standard deviation t by the following processing.

$$t = √ \{ m \hat{} 2 * abs ( std - m \hat{} 2 ) / nP \}$$

Here, std is a mean square sum, and nP is a constant. In the above expression, the operator symbol “\tilde{ }” indicates a power, and “abs” indicates an absolute value.

FIG. 16 is the threshold image TI in which the thresholds Th determined in the processing of (a) to (d) described above are set. In FIG. 16, the thresholds Th of the respective pixels determined in the processing of (a), (b), (c), and (d) are indicated by “a”, “b”, “c”, and “d”. The planar region threshold image generation unit 86 performs the processing of (a) to (d) described above on the pixels in the even-numbered column EC. The processing of (a) to (d) described above is not performed on the pixels in the odd-numbered column OC. For the pixels in the odd-numbered column OC, the thresholds set for the pixels in the even-numbered column EC are copied. In FIG. 16, the arrow mark “↑” refers to copying the same value as the threshold of the adjacent pixel indicated by the arrow as the threshold Th.

As illustrated in FIG. 16, the planar region threshold image generation unit 86 sets the same threshold for a pixel (the next pixel in the order of addresses) adjacent to the pixel corresponding to the processing of (d). Accordingly, the processing of the next pixel is skipped. Further, the processing is performed only on the even-numbered columns EC and, for the odd-numbered columns OC, the values of the even-numbered columns EC immediately above are copied. The planar region threshold image generation unit 86 generates the threshold image TI in this manner.

The edge region threshold image generation unit 87 includes a CPU that executes the edge region threshold image generation program. The edge region threshold image generation unit 87 compares the threshold Th1 of the edge region EA obtained by the edge region threshold calculation unit 83 with the threshold Th of the threshold image TI generated by the planar region threshold image generation unit 86. The edge region threshold image generation unit 87 updates the threshold image TI by resetting the larger value of the compared values as the threshold Th. In this manner, the threshold Th is set for each pixel for all pixels.

The binarization processing unit 88 includes a CPU that executes the binarization processing program.

The binarization processing unit 88 generates a binarized image by binarizing each pixel using the threshold Th set in the threshold image TI.

### Functions of Embodiment

Next, the functions of the image reading apparatus 11 will be described.

The user sets the security 50 such as a check in the image reading apparatus 11. The image reading apparatus 11 is caused to read an image of the security 50. The image reading apparatus 11 reads the image of the security 50.

The user operates the host device 100 or the image reading apparatus 11 to instruct execution of scanning. When receiving the scan instruction, the control section 70 starts reading the set document M1.

The control section 70 transports the document M1 by driving and controlling the drive unit 72. When second reading resolution is designated, the control section 70 transports the document M1 at a high speed.

The reading section 30 reads the document M1 being transported at the reading position. The reading section 30 outputs the read image SD obtained by reading the document M1. The control section 70 stores the read image SD in a predetermined storage area of the storage unit 73. The read image SD is, for example, a color image. The control section 70 converts the read image SD into the read image GD of a grayscale image. In this manner, the image acquisition unit 81 acquires the read image GD.

As below, processing performed by the control section 70 executing the program PG will be described with reference to the flowchart shown in FIG. 7.

In step S11, the control section 70 generates a histogram. Specifically, the image acquisition unit 81 generates the histogram H1 illustrated in FIG. 10.

In step S12, the control section 70 executes region separation processing.

In step S13, the control section 70 calculates an edge region threshold.

In step S14, the control section 70 calculates a threshold.

In step S15, the control section 70 calculates a mean edge intensity.

In step S16, the control section 70 generates the planar region threshold image TI.

In step S17, the control section 70 corrects the edge threshold.

In step S18, the control section 70 executes binarization processing. That is, the control section 70 generates a binarized image using the threshold Th.

The control section 70 executes the mean edge intensity calculation processing in step S15 in the following manner specifically based on the flowchart illustrated in FIG. 8.

First, in step S21, the control section 70 selects pixels of interest in even-numbered rows and even-numbered columns.

In step S22, the control section 70 calculates the edge intensity value of the pixel of interest. That is, the control section 70 calculates a variance using the brightness values of n×n pixels around the pixel of interest, and sets the variance as the edge intensity value. The control section 70 sets the calculated edge intensity value for the pixel of interest.

In step S23, the control section 70 applies the edge intensity value to each of the right, lower, and lower right pixels. That is, the control section 70 sets the same edge intensity value as that of the pixel of interest for each of the adjacent pixels located at the right, lower, and lower right sides of the pixel of interest.

In step S24, the control section 70 calculates a mean square sum and a mean and stores the values in the storage unit 73. That is, the control section 70 calculates the mean square sum std and the mean m using the brightness values of the n×n pixels read for calculating the variance in step S22. The control section 70 calculates the mean square sum std by dividing the sum of the squared brightness values of the n×n pixels by the number of pixels n². The control section 70 calculates the mean m by dividing the sum of the brightness values of the n×n pixels by the number of pixels n². The control section 70 stores the calculated mean square sum std and mean m in the storage unit 73 for use in subsequent processing.

In step S25, the control section 70 determines whether processing on all pixels of interest is finished. When the processing on all pixels of interests is not finished, the control section returns to the processing in step S21 and selects the next pixel of interest.

In this manner, the processing in steps S22 to S24 is executed for the next pixel of interest. Then, in step S25, the processing in steps S22 to S24 is executed while changing to the next pixel of interest until the processing on all pixels of interest is finished. When the processing in steps S22 to S24 is finished for all pixels of interest to be selected in step S21, an affirmative determination is made in step S25, and the control section proceeds to step S26.

In step S26, the control section 70 calculates a mean edge intensity value. That is, the mean edge intensity calculation unit 85 calculates the mean edge intensity value EM as the mean value of the edge intensity values EI by dividing the sum of the edge intensity values EI of all pixels by the number of pixels. In this manner, the control section 70 ends this routine.

The control section 70 executes the planar region threshold image generation processing in step S16 in the following manner specifically based on the flowchart illustrated in FIG. 9. The threshold Th is set with respect to each pixel for all pixels of the read image GD. That is, the planar region threshold image generation unit 86 of the control section 70 sets the threshold Th for each pixel by sequentially determining whether the pixel of interest satisfies the above described conditions shown by (a) to (d). The planar region threshold image generation unit 86 may sequentially select all pixels as the pixels of interest, but here, an example of selecting pixels in even-numbered columns is described.

First, in step S31, a pixel of interest in an even-numbered column is selected.

In step S32, the control section 70 determines whether the brightness value BV of the pixel of interest is larger than IMax. IMax is, for example, Imax=200. IMax is set to a value at which the pixel of interest can be clearly regarded as a background pixel when the brightness value of the pixel of interest is larger than IMax. The control section 70 proceeds to step S33 when BV>IMax is satisfied, and proceeds to step S34 when BV>IMax is not satisfied.

In step S33, the control section 70 sets the threshold Th of the pixel of interest to 0. The threshold Th=0 is a threshold that can set the pixel of interest to white by the binarization processing.

In step S34, the control section 70 determines whether the brightness value BV of the pixel of interest>GTh and the edge intensity value EI<EM. Here, GTh is the threshold GTh, and EM is the mean edge intensity value EM. That is, the control section 70 determines whether the second condition that the brightness value BV of the pixel of interest is larger than the threshold GTh and the edge intensity value EI is smaller than the mean edge intensity value EM is satisfied. The pixel of interest satisfying the second condition can be regarded as a background pixel with a high probability. The control section 70 proceeds to step S35 when the second condition that BV>GTh and EI<EM is satisfied, and proceeds to step S36 when the second condition is not satisfied.

In step S35, the control section 70 sets the threshold Th of the pixel of interest to 0. The threshold Th=0 is a threshold that can set the pixel of interest to white by the binarization processing.

In step S36, the control section 70 determines whether the brightness value BV of the pixel of interest is larger than VMin. Here, VMin is a constant multiple of the first threshold GTh. As an example, the constant may be a value from 0.2 or more and 0.6 or less. When BV>VMin is satisfied, the control section proceeds to step S37, and when BV>VMin is not satisfied, proceeds to step S38.

In step S37, the control section 70 sets the threshold Th of the pixel of interest to 255. The threshold Th=255 is a threshold at which the pixel of interest can be set to black by the binarization processing.

In step S38, the control section 70 sets the threshold Th=t+m*cf. That is, the control section 70 calculates the threshold Th using the standard deviation t and the mean m based on the n×n brightness values. Here, the control section 70 reads the mean square sum std and the mean m used for calculating the standard deviation t from the storage unit 73.

In step S39, the control section 70 determines whether processing on all pixel of interests is finished. When the processing on all pixels of interests is not finished, the control section returns to the processing in step S31 and selects the next pixel of interest. The control section 70 sequentially selects the pixels in the even-numbered columns as the pixels of interest. When the threshold Th is set by the processing in step S38, that is, when the threshold Th is set because the condition (d) is satisfied, the same threshold Th is set for the next pixel adjacent to the pixel of interest (see FIG. 16). In this case, in step S31, the control section 70 skips the next pixel and selects the pixel next to the next pixel as the pixel of interest.

In this manner, the control section 70 sequentially executes the processing in steps S32 to S38 for the next pixel of interest until the threshold Th is determined. Then, in step S39, the processing in steps S32 to S38 is similarly executed while changing to the next pixel of interest until the processing on all pixels of interest is finished. Then, when the control section 70 finishes setting the threshold Th for the last pixel of interest, an affirmative determination is made in step S39, and thus the control section ends this routine. In this manner, the planar region threshold image generation unit 86 of the control section 70 generates the planar region threshold image TI illustrated in FIG. 16.

When the planar region threshold image TI illustrated in FIG. 16 is acquired, the control section 70 executes edge threshold correction processing in the processing in step S17. That is, the control section 70 compares the threshold Th1 of the edge region EA calculated in step S13 with the threshold Th set for the corresponding pixel in the planar region threshold image TI. The control section 70 updates the threshold Th to the larger one of the thresholds Th1 and Th. That is, when determining that the threshold Th1 is larger than the threshold Th, the control section 70 updates (corrects) the planar region threshold image TI by rewriting the threshold Th of the corresponding pixel in the planar region threshold image TI to the threshold Th1. The control section 70 generates a threshold image by the update processing (correction processing).

The control section 70 generates the binarized image BI by executing the binarization processing on the read image GD using the threshold Th set for each pixel forming the threshold image. In this manner, the image reading apparatus 11 continuously reads a plurality of documents M1 such as standard size checks by the reading section 30. Then, processing is performed at a high speed from the start of reading to the generation of the binarized image BI. Therefore, the image reading apparatus 11 outputs the binarized image BI at a processing speed from 60 sheets or more and 100 sheets or less per minute. When the checks are continuously read, the binarized images BI of the checks in which the characters are easily distinguished from the backgrounds are obtained by high-speed processing. As a result, recognition processing of the character information of the checks can be performed accurately and quickly.

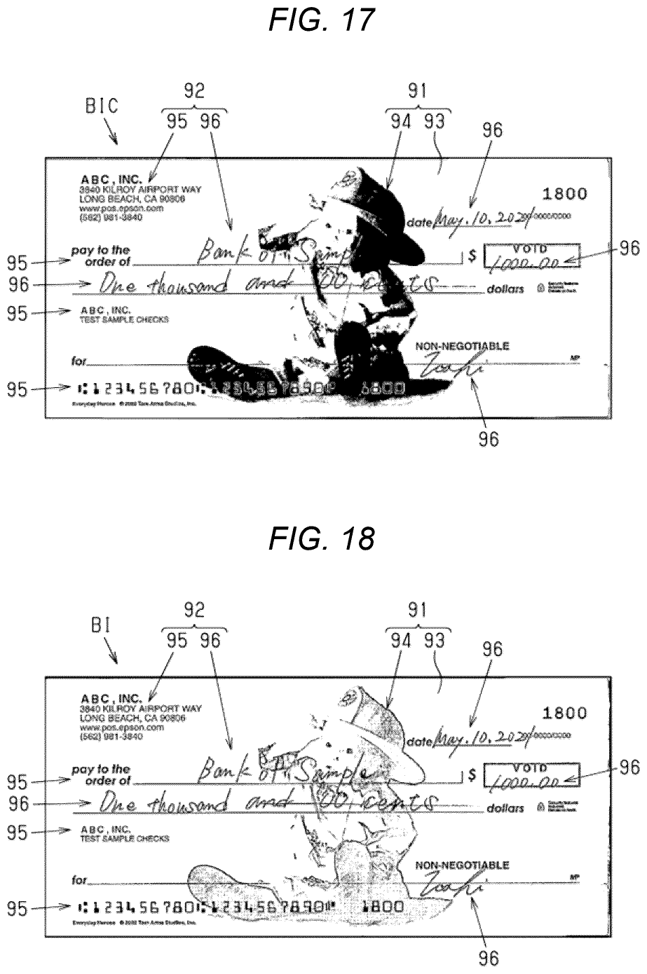

FIG. 17 shows a binarized image BIC of a comparative example, and FIG. 18 shows a binarized image of the example. The binarized images BIC and BI shown in FIGS. 17 and 18 include background images 91 corresponding to backgrounds and character images 92 corresponding to characters. The background images 91 include a ground pattern image 93 corresponding to the ground pattern 53 and a pattern image 94 corresponding to the design 54. The character images 92 include printed character images 95 corresponding to the printed characters 55 and handwritten character images 96 corresponding to the handwritten characters 56.

In the comparative example shown in FIG. 17, a part of the design image 94 of the background images 91 is black. Accordingly, parts of the printed character images 95 and the handwritten character images 96 are failed to be recognized due to the black parts of a part of the pattern image 94.

On the other hand, in the binarized image BI of the example shown in FIG. 18, the black region is remarkably reduced in the pattern image 94 of the background images 91. That is, in the binarized image BI, the binarization processing is performed such that the pattern image 94 of the background images 91 appears gray as a whole. Thus, the entire of the printed character images 95 and the handwritten character images 96 can be recognized without being obstructed by the black parts of the pattern image 94. The image reading apparatus 11 can therefore recognize characters with higher recognition accuracy when character recognition is performed from a read image obtained by reading a security such as a check.

Here, a method of confirming that the binarized image BI of the check is an image in which characters are easily recognized will be described. The document M1 shown in FIG. 3 is a check having an overlapping region in which the characters and the backgrounds overlap. In the binarized check image BI of the check, there are a plurality of overlapping regions of 1 square millimeter satisfying the following conditions. Here, the overlapping region is a region in which a character and a background are adjacent to each other. Accordingly, the overlapping region includes pixels of a character region (containing a region where a character and a background overlap) and pixels of a region containing only backgrounds.

As a method of confirming the mean brightness value of the region of 1 square millimeter contained in the background of the check as the document M1, the check is confirmed by measuring the color of the check with a colorimeter. The color of display data obtained by displaying an image of the check captured by a camera on a display may be measured by the colorimeter.

As a method of confirming the mean brightness value of the overlapping region of 1 square millimeter of the binarized image BI, for example, a printed matter obtained by printing the binarized image BI on a white sheet in gray scale is confirmed by a brightness value of image data read by a scanner, or is confirmed by measuring the color thereof using a colorimeter. As an example of the colorimeter, a colorimeter equipped with an etalon may be used to measure the color of the check image or the binarized image BI displayed on the display.

In the overlapping region of 1 square millimeter of the check shown in FIG. 3, a first mean brightness value as a mean brightness value of the character region is BV1, and a second mean brightness value as a mean brightness value of the background region is BV2. A difference A1 between the mean brightness values BV1 and BV2 is expressed by Δ1=abs (BV1−BV2).

In the overlapping region of 1 square millimeter of the binarized image BI shown in FIG. 18, a third mean brightness value as mean brightness value of the character region is BV3, and a fourth mean brightness value as a mean brightness value of the background region is BV4. A difference 42 between the mean brightness values BV3 and BV4 is expressed by Δ2=abs (BV3−BV4). Here, it is necessary to compare the mean brightness values BV1 and BV2 acquired from the check with the mean brightness values BV3 and BV4 acquired from the binarized image BI shown in FIG. 18 at the same grayscale level. Accordingly, in this example, the comparison is performed at 256 levels.

The difference between the differences Δ1 and 42 obtained from the overlapping regions at the same position corresponding to the check and the binarized image BI is expressed by abs (Δ1−Δ2). The expression abs (Δ1−Δ2) expressing the difference is used as a condition for evaluating that the binarized image BI of the check is an image in which characters are easily recognized.

In the binarized image BI of the example in which characters are easily recognized, there are a plurality of overlapping regions of 1 square millimeter satisfying that the difference abs (Δ1−Δ2) expressed by the above-described expression is “50” or more. For example, the number n of overlapping regions optionally selected from the binarized image BI is 10. In this case, in the binarized image BI of the example illustrated in FIG. 18, there are eight or more overlapping regions satisfying abs (Δ1−Δ2)≥50. In contrast, in the binarized image BIC of the comparative example illustrated in FIG. 17, the number of overlapping regions satisfying abs (Δ1 to Δ2)≥50 is 1 or less (0 or 1).

When n is more than 10, the evaluation can be performed substantially in the same manner. That is, in the binarized image BI of the example, the number of overlapping regions satisfying abs (Δ1 to Δ2)≥50 among the optionally selected n overlapping regions is 80% or more of the total. In contrast, in the binarized image BIC of the comparative example, the number of overlapping regions satisfying abs (Δ1−Δ2)≥50 is less than 20%, particularly 10% or less. Depending on the type of the check and the model of the existing image reading apparatus that reads the check, the ratio of the number of overlapping regions satisfying abs (Δ1 to Δ2)≥50 in the binarized image BIC slightly varies, but even when such a variation is taken into consideration, the ratio is less than 20%.

The following evaluation method may be employed instead of the above described evaluation method. A mean brightness value L1 of a predetermined region A1 in the character region of the check and a mean brightness value B1 of a predetermined region A2 in the background region of the check are calculated using the measurement result obtained by measuring the color of the check with the colorimeter. The predetermined regions A1 and A2 have predetermined areas. The predetermined area may be any area, for example, 0.1 square mm, 1 square mm, or 10 square mm. Using the calculation result, the difference in brightness value between the character region and the background region before the binarization processing can be regarded as abs (L1−B1).

A mean brightness value L2 of the predetermined region A1 in the character region of the binarized image BI of the check after the binarization processing and a mean brightness value B2 of the predetermined region A2 in the background region of the binarized image BI are calculated using a measurement result obtained by measuring the color thereof with a colorimeter or data after the binarization processing. When the color is measured by a colorimeter, display data displayed on a display is measured by, for example, a colorimeter equipped with an etalon. The predetermined regions A1 and A2 have predetermined areas, and the predetermined area may be any area, for example, 0.1 square mm, 1 square mm, or 10 square mm. Using the calculation result, the difference in brightness value between the character region and the background region after the binarization processing can be regarded as abs (L2−B2).

In the binarized image BI of the example, there are a plurality of sets of A1 and A2 in which abs (abs (L1−B1)−abs (L2−B2))>50 in, for example, optionally selected 10 sets (n=10) of predetermined regions A1 and A2. That is, in the binarized image BI of the example, among the n sets of optionally selected predetermined regions A1 and A2, there are sets of the predetermined regions A1 and A2 that satisfy abs (abs (L1−B1)−abs (L2 B2))≥50 at 80% or more of the total. In contrast, in the binarized image BIC of the comparative example, when n is 10 sets, the number of sets of A1 and A2 satisfying abs (abs (L1−B1)−abs (L2−B2))≥50 is 1 or less (0 or 1). That is, in the binarized image BIC of the comparative example, the set of A1 and A2 satisfying abs (abs (L1−B1)−abs (L2−B2))>50 is less than 20% of the total.

### Effects of Embodiment

According to the embodiment, the following effects can be obtained.

(1) The image reading apparatus 11 that reads the document M1 containing the backgrounds 51 and the characters 52 includes the reading section 30 that reads the document M1 and the control section 70. The control section 70 includes the image acquisition unit 81, the threshold setting unit, and the binarization processing unit 88. The threshold setting unit performs the threshold setting processing including the second processing and the third processing to set the threshold Th used for the binarization processing for each pixel of the read image GD. In the second processing, the threshold Th for binarizing the background pixels as the pixels of the background image contained in the read image GD into the first color that is one of black and white is set. In the third processing, the threshold Th for binarizing the character pixels as the pixels of the character image contained in the read image GD into the second color, which is the other color of black and white, is set. The binarization processing unit 88 generates the binarized image BI from the read image GD based on the threshold Th set for each pixel. The threshold setting processing includes processing of setting the threshold Th determined based on each brightness value of n×n pixels including a pixel as a pixel of interest for the pixel of interest by the threshold setting unit. According to the configuration, since the appropriate threshold Th is set for each pixel of the read image GD, the binarized image BI in which characters are easily distinguished from the backgrounds can be acquired.

(2) The planar region threshold image generation unit 86 provided in the threshold setting unit sets the threshold Th based on the standard deviation and the mean determined from each brightness value of n×n pixels (where n is a natural number of 2 or more) including the pixel of interest for the pixel of interest. According to the configuration, since the threshold Th based on the standard deviation and the mean is set for each pixel of the read image GD, the binarized image BI in which characters are easily distinguished from the backgrounds can be acquired.

(3) The first color is white, and the second color is black. A predetermined brightness value with which a pixel can be regarded as a background pixel is set as the first determination value. As one piece of the second processing, the planar region threshold image generation unit 86 provided in the threshold setting unit sets the threshold Th for binarizing a pixel satisfying the first condition that the pixel has a brightness value larger than the first determination value into white.

According to the configuration, since the appropriate threshold Th is set for each pixel of the read image GD, the binarized image BI in which characters are easily distinguished from the backgrounds can be acquired.

(4) The threshold calculation unit 84 provided in the control section 70 sets a pixel group having brightness values equal to or smaller than a boundary value (threshold T) as the first class and a pixel group having brightness values larger than the boundary value as the second class while changing the boundary value of the brightness value in the histogram H1 of the read image GD. The control section 70 sets the boundary value (threshold T) at which the degree of separation S as a ratio between the intra-class variance of the first class and the inter-class variance between the first class and the second class becomes the maximum as the second determination value (first threshold GTh). As one piece of the second processing, the planar region threshold image generation unit 86 forming the threshold setting unit sets the threshold Th for binarizing a pixel satisfying the second condition that the pixel has a brightness value larger than the second determination value into white. According to the configuration, since the appropriate threshold Th is set for each pixel of the read image GD, the binarized image BI in which characters are easily distinguished from the backgrounds can be acquired.

(5) As one piece of the third processing, the planar region threshold image generation unit 86 forming the threshold setting unit sets the threshold Th for binarizing a pixel satisfying the third condition that the pixel has a brightness value larger than a value obtained by multiplying the second determination value by the predetermined value Cm (0.2≤Cm≤0.6) into black.

According to the configuration, since the appropriate threshold Th is set for each pixel of the read image GD, the binarized image BI in which characters are easily distinguished from the backgrounds can be acquired.

(6) The control section 70 includes the mean edge intensity calculation unit 85 that calculates the variance as the edge intensity value EI based on the brightness values of n² pixels in the range of n×n pixels with each pixel of the read image GD as the pixel of interest, and calculates the mean edge intensity value EM as the mean of the edge intensity values EI. In addition to or instead of having the brightness value larger than the second determination value (first threshold GTh), in the planar region threshold image generation unit 86 forming the threshold setting unit, the second condition includes the edge intensity value EI being less than the mean edge intensity value EM.

According to the configuration, since the appropriate threshold Th is set for each pixel of the read image GD, the binarized image BI in which characters are easily distinguished from the backgrounds can be acquired.

(7) The mean edge intensity calculation unit 85 selects the pixels in the even-numbered columns and even-numbered rows of the read image GD as pixels of interests. According to the configuration, since the number of pixels to be processed can be reduced by processing not all pixels of the read image GD, the throughput from the start of reading the document M1 to the output of the binarized image BI is improved.

(8) The image reading apparatus 11 includes the storage unit 73 in which the read image GD is stored. The threshold setting unit includes the planar region threshold image generation unit 86 that generates the planar region threshold image TI having the threshold Th set for a pixel as a pixel value. When each brightness value of n×n pixels is read from the storage unit 73, the mean edge intensity calculation unit 85 calculates the mean and the mean square sum of n×n brightness values and stores the values in the storage unit 73. The planar region threshold image generation unit 86 sets the threshold Th determined based on each brightness value of n×n pixels based on the mean and the mean square sum read from the storage unit 73. According to the configuration, since the number of access to the storage unit 73 is significantly reduced, the processing time is shortened. Therefore, the throughput from the start of reading the document M1 to the output of the binarized image BI can be further improved.

(9) The mean edge intensity calculation unit 85 assigns the edge intensity value EI having the same value as that of the pixel of interest to one or more pixels among the pixels adjacent to the pixel of interest.

According to the configuration, the edge intensity value EI can be set for one or more pixels adjacent to the pixel of interest even when the calculation processing of the edge intensity value EI is omitted. Therefore, the improvement in throughput and the improvement in quality of the binarized image BI can be implemented.

(10) When the reading section 30 continuously reads standard-size checks as the documents M1, the binarized image BI can be output at a processing speed from 60 or more and 100 or less sheets per minute. According to the configuration, when the checks are continuously read, the binary images BI of the checks in which the characters can be easily distinguished from the backgrounds can be obtained in the high-speed processing. Thus, the recognition processing of the character information of the checks can be performed accurately and quickly.

(11) The control section 70 has the CPU and the storage unit 73. The CPU performs processing including first processing and threshold setting processing by executing the program stored in the storage unit 73. According to the configuration, the image reading apparatus 11 performs the processing from the acquisition of the read image GD to the generation of the binarized image BI by the CPU. For example, since it is not necessary for the image reading apparatus 11 to exchange data with the external host device 100 (PC or the like) until the binarized image BI is generated, the throughput can be improved.

(12) The threshold setting unit includes the edge region threshold calculation unit 83 that sets the threshold Th1 for the pixels in the edge region as a region with continuous character pixels as one piece of the third processing. The edge region threshold calculation unit 83 sets, as the threshold Th1, the brightness value when the cumulative number of pixels from the smaller brightness values in the histogram based on the brightness values of the pixels in the edge region reaches a predetermined ratio to the total number of pixels in the edge region. The threshold setting unit updates the threshold Th of the pixel of interest to the larger one of the threshold Th determined based on each brightness value of n×n pixels and the threshold Th1 set by the edge region threshold calculation unit 83. According to the configuration, the threshold Th of the pixel in the edge region (character region) can be updated to a more appropriate value. Therefore, the binarized image BI in which the characters are more easily distinguished from the backgrounds can be acquired.

(13) In an image reading method, with the reading section 30 that reads the document M1 and the control section 70, the control section 70 performs the following steps (S1) to (S3).

(S1) Performing the first processing of acquiring the read image GD including a background image and a character image by causing the reading section 30 to read the document M1.

(S2) Performing the threshold setting processing including the second processing of setting the threshold Th for binarizing the background pixels as the pixels of the background image contained in the read image GD into the first color, which is one color of black and white, and the third processing of setting the threshold Th for binarizing the character pixels as the pixels of the character image contained in the read image GD into the second color, which is the other color of black and white, thereby setting the threshold Th used for the binarization processing for each pixel of the read image GD.

(S3) Generating the binarized image BI from the read image GD based on the threshold Th set for each pixel.

In (S2), the threshold setting processing includes processing of setting the threshold Th determined based on each brightness value of the n×n pixels containing the pixel as the pixel of interest for the pixel of interest.

According to the method, since the appropriate threshold Th is set for each pixel of the read image GD, the binarized image BI in which characters are easily distinguished from the backgrounds can be acquired.

(15) The program PG includes the following steps (P1) to (P3) to be executed by a computer.

(P1) performing first processing of acquiring the read image GD containing the background image and the character image by the image acquisition unit of the computer to cause the reading portion 30 to read the document M1, (P2) performing the threshold setting processing including the second processing of setting the threshold Th for binarizing the background pixel as the pixel of the background image contained in the read image GD into the first color, which is one color of black and white, and the third processing of setting the threshold Th for binarizing the character pixel as the pixel of the character image contained in the read image GD into the second color, which is the other color of black and white, thereby setting the threshold Th used for the binarization processing for each pixel of the read image GD by the threshold setting unit of the computer, (P3) generating the binarized image BI from the read image GD based on the threshold Th set for each pixel by the binarization processing unit 88 of the computer, and, in (P2), the threshold setting processing includes the processing of setting the threshold Th determined based on each brightness value of n×n pixels containing the pixel as the pixel of interest for the pixel of interest.

According to the program, since the appropriate threshold Th is set for each pixel of the read image GD, the binarized image BI in which characters are easily distinguished from the backgrounds can be acquired.

### MODIFIED EXAMPLES

The above embodiment can be modified as the following modified examples. Further, an appropriate combination of the above described embodiment and the following modified examples can be used as another modified example, and an appropriate combination of the following modified examples can be used as another modified example.

In the above described embodiment, n in n×n (where n is a natural number of 2 or more) is set to n=5, but n may be 2 or more. Further, n may be an odd number that allows the pixel of interest to be disposed at the center position within the range of n×n. n may be an even number because, even when the pixel of interest cannot be disposed at the center position within the range of n×n, the pixel of interest can be disposed at a position closest to the center position compared to the other pixels. In the case of an even number, there are a plurality of pixels at the shortest distance to the center position of the range of the pixel of interest, however, the threshold of the pixel of interest can be set. For example, n may be any one of 2, 3, 4, 6, 7, 8, 9, 10, and 11. n may be a value other than these values, however, when n becomes too large, the calculation amount increases, which is likely to cause a decrease in throughput. Thus, an appropriate value according to the performance of the image reading apparatus 11 such as the processing speed may be selected.

In the control section 70, the pixel of interest to be selected as the pixel of interest in the processing of sequentially determining whether the above described conditions shown in (a) to (d) are satisfied for the pixel of interest by the planar region threshold image generation unit 86 that performs the planar region threshold image generation process in step S16 is not limited to the pixels in the even-numbered column, but may be the pixels in the even-numbered column and the even-numbered row as in FIG. 8.

In the above described embodiment, the binarized image BI is generated from the read image GD to set the background pixels in white as the first color and the character pixels in black as the second color, however, the binarized image BI may be generated to set the first color to black and the second color to white.

In the processing of the above-described (a), the threshold for binarization into white is not limited to Th=0. The threshold for binarization into white may be a value larger than 0 and equal to or smaller than the first threshold GTh.

In the processing of the above-described (b), the threshold for binarization into white is not limited to Th=0. The threshold for binarization into white may be a value larger than 0 and equal to or smaller than the first threshold GTh.

The second condition in the processing of the above-described (b) may be only one of the brightness value BV of the pixel of interest>GTh and the edge intensity value EI<EM instead of both. That is, the second condition may be that the brightness value Bv of the pixel of interest>GTh is satisfied or that the edge intensity value EI<EM is satisfied.

The mean edge intensity calculation unit 85 selects the pixels in the even-numbered columns and the even-numbered rows of the read image GD as the pixels of interests, however, may select only the pixels in the even-numbered columns or the even-numbered rows as the pixels of interests. Or, the mean edge intensity calculation unit 85 may select the pixels in the odd-numbered columns and the odd-numbered rows of the read image GD as the pixels of interest, or may select only the pixels in odd-numbered columns or the odd-numbered rows as the pixels of interest.

Although the thinning processing of the columns and the rows of the read image GD is performed for shortening the processing time, the thinning processing is not necessarily performed.

The image reading apparatus 11 may be provided in a multifunction peripheral having a scanner, a printing function, and a copying function as a part thereof. An automatic document feeder (automatic sheet feeder) that automatically feeds documents may be provided.

The program PG illustrated in the flowcharts of FIGS. 7 to 9 may be executed by a computer of the host device 100. Specifically, a scan driver program or an application program for adding a function installed in the computer of the host device 100 may include the program PG illustrated in the flowcharts of FIGS. 7 to 9. When the computer of the host device 100 executes the program PG, for example, a scan driver (reading control device) may include at least part of the units 81 to 88 illustrated in FIG. 6, which are implemented by software. The units 81 to 88 illustrated in FIG. 6 may be provided only in the host device 100, or may be separately provided in the image reading apparatus 11 and the host device 100.

The image reading apparatus 11 is not limited to the configuration having the security reading function, but may be a sheet-feed image reading apparatus 11 or a flatbed image reading apparatus 11.

The image sensor forming the reading section 30 may be a CMOS image sensor, a MOS (Metal Oxide Semiconductor) image sensor, or a CCD (charge coupled device) image sensor.

The image sensor forming the reading section 30 may be a linear image sensor or an area image sensor.

Each functional unit in the control section 70 is not limited to being implemented by the CPU, and may be implemented by hardware using an electronic circuit such as an ASIC (application specific integrated circuit) or an FPGA (field-programmable gate array), or may be implemented by both software and hardware.

The material of the document is not limited to paper, but may be a resin film, a resin sheet, a metal film, a foil, or the like.

### APPENDICES

As below, the technical ideas grasped from the above described embodiment and the modified examples will be described together with effects.

(A) An image reading apparatus is an image reading apparatus that reads a document containing a background and a character including a reading section that reads the document, and a control section, wherein the control section includes an image acquisition unit that performs first processing of acquiring a read image containing a background image and a character image by causing the reading section to read the document, a threshold setting unit that performs threshold setting processing including second processing of setting a threshold for binarizing a background pixel as a pixel of the background image contained in the read image into a first color that is one color of black and white and third processing of setting a threshold for binarizing a character pixel as a pixel of the character image contained in the read image into a second color that is the other color of black and white, thereby setting the threshold used for binarization processing for each pixel of the read image, and a binarization processing unit that generates a binarized image from the read image based on the threshold set for each pixel, and the threshold setting processing includes processing of setting a threshold determined based on each brightness value of n×n pixels containing the pixel as a pixel of interest for the pixel of interest by the threshold setting unit. According to the configuration, since the appropriate threshold is set for each pixel of the read image, the binarized image in which the character is easily distinguished from the background can be acquired.

(B) In the image reading apparatus according to the above-described (A), the threshold setting unit may set the threshold based on a standard deviation and a mean determined from each brightness value of the n×n pixels containing the pixel of interest for the pixel of interest, n being a natural number of 2 or more. According to the configuration, since the threshold based on the standard deviation and the mean is set for each pixel of the read image, the binarized image in which the character is easily distinguished from the background can be acquired.

(C) In the image reading apparatus according to the above-described (B), the first color may be white and the second color may be black, a predetermined brightness value regardable as the background pixel may be set as a first determination value, and the threshold setting unit may set the threshold for binarizing the pixel for which a first condition that the pixel has a brightness value larger than the first determination value is satisfied into white for the pixel as one piece of the second processing. According to the configuration, since the appropriate threshold is set for each pixel of the read image, the binarized image in which the character is easily distinguished from the background can be acquired.

(D) In the image reading apparatus according to the above-described (C), the control section may set a pixel group having a brightness value equal to or smaller than a boundary value as a first class and a pixel group having a brightness value larger than the boundary value as a second class while changing the boundary value of the brightness value in a histogram of the read image, and sets the boundary value at which a degree of separation as a ratio between an intra-class variance of the first class and an inter-class variance between the first class and the second class becomes the maximum as a second determination value, and the threshold setting unit may set the threshold for binarizing the pixel for which a second condition that the pixel has a brightness value larger than the second determination value is satisfied into white for the pixel as one piece of the second processing. According to the configuration, since the appropriate threshold is set for each pixel of the read image, the binarized image in which the character is easily distinguished from the background can be acquired.

(E) In the image reading apparatus according to the above-described (D), the threshold setting unit may set the threshold for binarizing the pixel for which a third condition that the pixel has a brightness value larger than a value obtained by multiplying the second determination value by the predetermined value Cm, where 0.2≤Cm≤0.6, is satisfied into black for the pixel as one piece of the third processing. According to the configuration, since the appropriate threshold is set for each pixel of the read image, the binarized image in which the character is easily distinguished from the background can be acquired.

(F) In the image reading apparatus according to the above-described (D) or (E), the control section may include a mean edge intensity calculation unit that calculates a variance as an edge intensity value based on brightness values of n² pixels in a range of the n×n pixels in which each pixel of the read image is a pixel of interest, and calculates a mean edge intensity value as a mean of the edge intensity values, and the threshold setting unit may include, in the second condition, a condition that the edge intensity value is smaller than the mean edge intensity value in addition to or instead of the pixel having a brightness value larger than the second determination value. According to the configuration, since the appropriate threshold is set for each pixel of the read image, the binarized image in which the character is easily distinguished from the background can be acquired.

(G) In the image reading apparatus according to the above-described (F), the mean edge intensity calculation unit may select pixels in even-numbered columns and even-numbered rows of the read image as the pixels of interest. According to the configuration, since the number of pixels to be processed can be reduced without processing all pixels of the read image, the throughput from the start of reading the document to the output of the binarized image is improved.

(H) In the image reading apparatus according to the above-described (G), the image reading apparatus may further include a storage unit in which the read image is stored, wherein the threshold setting unit may include a planar region threshold image generation unit that generates a planar region threshold image having the threshold set for the pixel as a pixel value, the mean edge intensity calculation unit may calculate a mean and a mean square sum of n×n brightness values when each brightness value of the n×n pixels is read from the storage unit and stores the mean and the mean square sum in the storage unit, and the planar region threshold image generation unit may set the threshold determined based on each brightness value of the n×n pixels based on the mean and the mean square sum read from the storage unit. According to the configuration, since the number of access to the storage unit is significantly reduced, the processing time is shortened. Therefore, the throughput from the start of reading the document to the output of the binarized image can be further improved.

(I) In the image reading apparatus according to the above-described (G) or (H), the mean edge intensity calculation unit may assign the edge intensity value having the same value as the pixel of interest to one or more pixels among pixels adjacent to the pixel of interest. According to the configuration, the edge intensity value can be set for one or more pixels adjacent to the pixel of interest even when the calculation processing of the edge intensity value is omitted. Therefore, the improvement in throughput and the improvement in quality of the binarized image can be implemented.

(J) In the image reading apparatus according to any one of the above-described (G) to (I), the reading section may be configured to output the binarized images at a processing speed from 60 sheets to 100 sheets per minute when continuously reading standard-size checks as the documents. According to the configuration, when checks are continuously read, binarized images of the checks in which characters can be easily distinguished from the backgrounds can be obtained by high-speed processing. Thus, the recognition processing of the character information of the checks can be performed accurately and quickly.

(K) In the image reading apparatus according to any one of the above-described (A) to (J), the threshold setting unit may include an edge region threshold calculation unit that sets a threshold for the pixel in an edge region as a region in which the character pixels are continuous as one piece of the third processing, the edge region threshold calculation unit may set, as the threshold, a brightness value when a cumulative number of pixels from smaller brightness values in a histogram based on brightness values of the pixels in the edge region reaches a predetermined ratio to a total number of pixels in the edge region, and the threshold setting unit may update a larger one of the threshold determined based on each brightness value of the n×n pixels and the threshold set by the edge region threshold calculation unit as the threshold of the pixel of interest. According to the configuration, the threshold of the pixel in the edge region (character region) can be updated to a more appropriate value. Therefore, the binarized image in which the character is more easily distinguished from the background can be acquired.

(L) In the image reading apparatus according to any one of the above-described (A) to (K), the control section may include a CPU and a storage unit, and the CPU may execute a program stored in the storage unit, thereby performing processing including the first processing and the threshold setting processing. According to the configuration, the image reading apparatus performs the processing from the acquisition of the read image to the generation of the binarized image by the CPU. For example, since it is not necessary for the image reading apparatus to exchange data with an external host device (PC or the like) before generating a binary image, the throughput can be improved.

(M) An image reading method of reading a document containing a background and a character, with a reading section that reads the document and a control section, the method includes, by the control section, performing first processing of acquiring a read image containing a background image and a character image by causing the reading section to read the document, performing threshold setting processing including second processing of setting a threshold for binarizing a background pixel as a pixel of the background image contained in the read image into a first color that is one color of black and white and third processing of setting a threshold for binarizing a character pixel as a pixel of the character image contained in the read image into a second color that is the other color of black and white, thereby setting the threshold used for binarization processing for each pixel of the read image, and generating a binarized image from the read image based on the threshold set for each pixel, and the threshold setting processing includes processing of setting a threshold determined based on each brightness value of n×n pixels containing the pixel as a pixel of interest for the pixel of interest. According to the method, since an appropriate threshold is set for each pixel of the read image, the binarized image in which the character is easily distinguished from the background can be acquired.

(N) A non-transitory computer-readable storage medium storing a program, the program causes a computer provided in an image reading apparatus that reads a document containing a background and a character to execute image reading processing including performing first processing of acquiring a read image containing a background image and a character image by causing a reading section to read the document by an image acquisition unit of the computer, performing threshold setting processing including second processing of setting a threshold for binarizing a background pixel as a pixel of the background image contained in the read image into a first color that is one color of black and white and third processing of setting a threshold for binarizing a character pixel as a pixel of the character image contained in the read image into a second color that is the other color of black and white, thereby setting the threshold used for binarization processing for each pixel of the read image by a threshold setting unit of the computer, and generating a binarized image from the read image based on the threshold set for each pixel by a binarization processing unit of the computer, wherein the threshold setting processing includes processing of setting a threshold determined based on each brightness value of n×n pixels containing the pixel as a pixel of interest for the pixel of interest. According to the program, since an appropriate threshold is set for each pixel of the read image, the binarized image in which the character is easily distinguished from the background can be acquired.

What is claimed is:

1. An image reading apparatus that reads a document containing a background and a character, the apparatus comprising:
a reading section that reads the document; and
a control section, wherein
the control section includes
an image acquisition unit that performs first processing of acquiring a read image containing a background image and a character image by causing the reading section to read the document,
a threshold setting unit that performs threshold setting processing including second processing of setting a threshold for binarizing a background pixel as a pixel of the background image contained in the read image into a first color that is one color of black and white and third processing of setting a threshold for binarizing a character pixel as a pixel of the character image contained in the read image into a second color that is the other color of black and white, thereby setting the threshold used for binarization processing for each pixel of the read image, and
a binarization processing unit that generates a binarized image from the read image based on the threshold set for each pixel, and
the threshold setting processing includes processing of setting a threshold determined based on each brightness value of n×n pixels containing the pixel as a pixel of interest for the pixel of interest by the threshold setting unit.

2. The image reading apparatus according to claim 1, wherein
the threshold setting unit sets the threshold based on a standard deviation and a mean determined from each brightness value of the n×n pixels containing the pixel of interest for the pixel of interest, n being a natural number of 2 or more.

3. The image reading apparatus according to claim 2, wherein
the first color is white and the second color is black,
a predetermined brightness value regardable as the background pixel is set as a first determination value, and
the threshold setting unit sets the threshold for binarizing the pixel for which a first condition that the pixel has a brightness value larger than the first determination value is satisfied into white for the pixel as one piece of the second processing.

4. The image reading apparatus according to claim 3, wherein,
the control section sets a pixel group having a brightness value equal to or smaller than a boundary value as a first class and a pixel group having a brightness value larger than the boundary value as a second class while changing the boundary value of the brightness value in a histogram of the read image, and sets the boundary value at which a degree of separation as a ratio between an intra-class variance of the first class and an inter-class variance between the first class and the second class becomes the maximum as a second determination value, and
the threshold setting unit sets the threshold for binarizing the pixel for which a second condition that the pixel has a brightness value larger than the second determination value is satisfied into white for the pixel as one piece of the second processing.

5. The image reading apparatus according to claim 4, wherein
the threshold setting unit sets the threshold for binarizing the pixel for which a third condition that the pixel has a brightness value larger than a value obtained by multiplying the second determination value by a predetermined value Cm, where 0.2≤Cm≤0.6, is satisfied into black for the pixel as one piece of the third processing.

6. The image reading apparatus according to claim 4, wherein
the control section includes a mean edge intensity calculation unit that calculates a variance as an edge intensity value based on brightness values of n² pixels in a range of the n×n pixels in which each pixel of the read image is a pixel of interest, and calculates a mean edge intensity value as a mean of the edge intensity values, and
the threshold setting unit includes, in the second condition, a condition that the edge intensity value is smaller than the mean edge intensity value in addition to or instead of the pixel having a brightness value larger than the second determination value.

7. The image reading apparatus according to claim 6, wherein
the mean edge intensity calculation unit selects pixels in even-numbered columns and even-numbered rows of the read image as the pixels of interest.

8. The image reading apparatus according to claim 7, further comprising a storage unit in which the read image is stored, wherein
the threshold setting unit includes a planar region threshold image generation unit that generates a planar region threshold image having the threshold set for the pixel as a pixel value,
the mean edge intensity calculation unit calculates a mean and a mean square sum of n×n brightness values when each brightness value of the n×n pixels is read from the storage unit and stores the mean and the mean square sum in the storage unit, and
the planar region threshold image generation unit sets the threshold determined based on each brightness value of the n×n pixels based on the mean and the mean square sum read from the storage unit.

9. The image reading apparatus according to claim 7, wherein
the mean edge intensity calculation unit assigns the edge intensity value having the same value as the pixel of interest to one or more pixels among pixels adjacent to the pixel of interest.

10. The image reading apparatus according to claim 7, wherein
the reading section is configured to output the binarized images at a processing speed from 60 or more sheets to 100 or less sheets per minute when continuously reading standard-size checks as the documents.

11. The image reading apparatus according to claim 1, wherein
the control section includes a CPU and a storage unit, and
the CPU executes a program stored in the storage unit, thereby performing processing including the first processing and the threshold setting processing.

12. The image reading apparatus according to claim 1, wherein
the threshold setting unit includes an edge region threshold calculation unit that sets a threshold for the pixel in an edge region as a region in which the character pixels are continuous as one piece of the third processing,
the edge region threshold calculation unit sets, as the threshold, a brightness value when a cumulative number of pixels from smaller brightness values in a histogram based on brightness values of the pixels in the edge region reaches a predetermined ratio to a total number of pixels in the edge region, and
the threshold setting unit updates a larger one of the threshold determined based on each brightness value of the n×n pixels and the threshold set by the edge region threshold calculation unit as the threshold of the pixel of interest.

13. An image reading method of reading a document containing a background and a character, with a reading section that reads the document and a control section, the method comprising:
by the control section,
performing first processing of acquiring a read image containing a background image and a character image by causing the reading section to read the document;
performing threshold setting processing including second processing of setting a threshold for binarizing a background pixel as a pixel of the background image contained in the read image into a first color that is one color of black and white and third processing of setting a threshold for binarizing a character pixel as a pixel of the character image contained in the read image into a second color that is the other color of black and white, thereby setting the threshold used for binarization processing for each pixel of the read image; and
generating a binarized image from the read image based on the threshold set for each pixel, wherein
the threshold setting processing includes processing of setting a threshold determined based on each brightness value of n×n pixels containing the pixel as a pixel of interest for the pixel of interest.

14. A non-transitory computer-readable storage medium storing a program, the program causing a computer provided in an image reading apparatus that reads a document containing a background and a character to execute image reading processing comprising:
performing first processing of acquiring a read image containing a background image and a character image by causing a reading section to read the document by an image acquisition unit of the computer,
performing threshold setting processing including second processing of setting a threshold for binarizing a background pixel as a pixel of the background image contained in the read image into a first color that is one color of black and white and third processing of setting a threshold for binarizing a character pixel as a pixel of the character image contained in the read image into a second color that is the other color of black and white, thereby setting the threshold used for binarization processing for each pixel of the read image by a threshold setting unit of the computer, and
generating a binarized image from the read image based on the threshold set for each pixel by a binarization processing unit of the computer, wherein
the threshold setting processing includes processing of setting a threshold determined based on each brightness value of n×n pixels containing the pixel as a pixel of interest for the pixel of interest.
